(19) United States
(12) Patent Application Publication
(10) Pub. No.: US 2007/0072098 A1
(43) Pub. Date: Mar. 29, 2007

(54) Optical recording medium

(76) Inventor: Rifat Ata Mustafa Hikmet, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,687

(22) PCT Filed: May 18, 2004
(86) PCT No.: PCT/IB04/50735

§ 371 Date: Nov. 22, 2005

(30) Foreign Application Priority Data
May 28, 2003 (EP) 03101566.2

(51) Int. Cl. G03C 3/00

(52) U.S. Cl. 430/18

(57) ABSTRACT

Disclosed is an optical recording medium comprising inorganic particles of nanometer size capable to undergo a change in size upon heating at a temperature above room temperature; and comprising a polymer in which the inorganic particles are dispersed to form a composite polymer. According to a preferred embodiment, the change in size is detectable by a change in the absorption spectrum of the composite polymer.

The present invention relates to an optical recording medium.

Various systems have been described using the principle of luminescence for optical recording and these systems have been combined with methods to produce multi-layers which can be used in the production of Write Once Read Many (WORM) and Read Only Memory (ROM) discs. Summaries of relevant disclosure are given below.

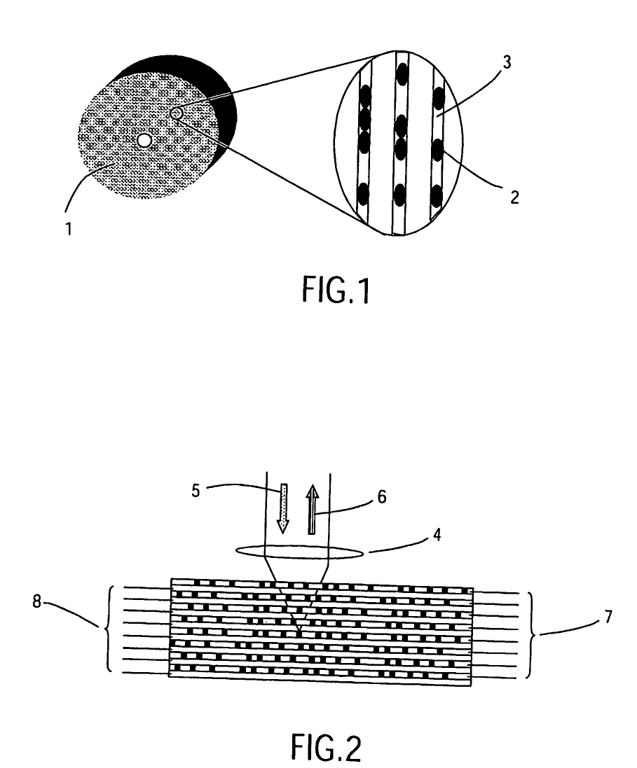

FIG. 1 schematically shows such a disc 1 where information 2 is written in tracks 3. The cross section of a recording disc along a section of track is schematically shown in FIG. 2.

The layer of FIG. 2 contains the recorded information 7 and transparent layers 8 in between. In multilayer recording concepts based on fluorescence, a beam 5 is focused on a spot which is used for both writing and reading. Heat can be used for recording and reading is done by detecting the luminescence (beam 6) induced by beam 5. The beam 5 is focused through several layers 7 and 8. It may therefore be important under these circumstances to have a material with a large Stoke shift so that the emission occurs far away from the absorption band. In this way emitted light 6 (fluorescent light) can travel through the layers without getting absorbed. A third layer can also be placed either underneath or above the recording layer in order to enhance or facilitate recording. Such a layer can be thermochromic or photochromic layer.

U.S. Pat. No. 5,399,451 discloses digital recording of information by utilizing the bistable isomers of a photo-reactive bistable quencher by irradiating the medium with light in the wavelength to be absorbed by the fluorescent material, whereby energy is transferred from the fluorescent material to the photo-reactive bistable quencher. Reading is made by irradiating the medium with a weaker light and detecting the fluorescence emitted by the fluorescent material.

U.S. Pat. No. 6,027,855 describes photochemical transformation of non-fluorescent rhodamine B lactams into fluorescent rhodamine B derivatives which can be used in Read Only Memory (ROM). Similarly, U.S. Pat. No. 5,945,252 discloses transformation of non-fluorescent peri-phenoxiderivatives of polycyclic quinones into fluorescent amino derivatives of anaquinones for (ROM).

EP 0 280 284 describes the use of an electron acceptor and an electron donor in a heat sensitive recording material containing a special fluorescent dye and/or a fluorescent pigment in the color-developing layer. The recording material in accordance with the underlying invention possesses a superior local acquisition capability on exposure to UV light and good optical readability in the near infrared region.

In WO 00/15 425, a dye-in-polymer composition for use in fluorescent Write Once Read Many (WORM) discs comprises about 0.1 to 10 percent by weight of a fluorescent dye capable of absorbing laser radiation and transforming the absorbed light into heat; about 10 to 80 percent by weight of nitrocellulose and a film forming polymer. The dye containing solution is applied to a substrate of an optical reading medium by spin, roller or dip coating. The method utilizes a focused laser beam for scanning the recording layer.

WO 00/48 178 discloses an optical recording medium for fluorescent WORM discs comprising a fluorescent dye, nitrocellulose and film-forming polymer. The medium provides a high capacity optical memory for WORM discs, including three dimensional optical memory systems

WO 00/55 850 describes a method for manufacturing a multi-layer optical information carrier with fluorescence reading/recording. A structure is fabricated, being formed of a substrate carrying a fluorescent film on one or both surfaces thereof, wherein the substrate is transparent with respect to incident radiation used for the fluorescence reading/recording. A patterned structure is applied to the fluorescent film under predetermined process conditions, such as to produce a fluorescent patterned structure with a surface relief in the form of an array of discrete fluorescent regions. The same procedure is repeated a required number of times, so as to obtain at the end of the process a multi-layer optical information carrier.

Finally, WO 01/06 505 describes a WORM type multilayer optical memory having photosensitive layers with fluorescent reading. The disc contains a transparent substrate and multiple information layers spatially divided from one another by polymer layers and assembled using adhesive layers. Information is stored in a photosensitive substance within spiral grooves. The photosensitive substance can be formed as a continuous layer or as discrete grooves on a non-photosensitive background. Various compositions for the photosensitive substance allow recording in by changing fluorescence bleaching or emitting, with threshold-type recording.

Despite the broad technical disclosure given in the patent literature cited above, there is still a demand for an improved optical recording medium. In particular, it is common to the above optical recording media that they are based on organic compounds as the photo-active component. Such systems have the drawback that organic compounds may be instable and may be sensitive to bleaching.

It is the object of the present to overcome the above drawbacks and to provide an optical recording medium which is based on a stable photo-active component.

This object is attained by an optical recording medium as defined in claim 1. Preferred embodiments of the optical recording medium are described in the sub-claims.

The inorganic particles contained in the polymer composites of the invention are basically of nanometer size. Their properties are influenced by their size. A gradual transition from bulk to molecular structure occurs as the particle size decreases, and vice versa. Particles showing these quantization effects are often called quantum dots. They show size dependent optical and electronic behavior. For example, the band gap of these materials can show increase by several electron volts with respect to the bulk material with decreasing particle size. This is reflected in the absorption and the photoluminescence spectra of the materials that shift hundreds of nanometers with decreasing particle size.

The size of the above particles may be affected by applying heat after production of the composite polymer. This measure can cause the particles to change in size.

The size of the inorganic particles may be affected by applying heat after production of the composite polymer. This measure has different effects depending on the behavior of the inorganic particles.

There are inorganic particles which tend to of agglomerate upon heating, thus growing in size. In this case, the change in size is an increase. CdS is a representative of this type of inorganic particles.

There are other inorganic particles which undergo heat induced chemical conversions leading to a decrease in size. An example for this type of inorganic particles is CdSe which is partly converted into CdO when heated in atmospheric air. Such conversion is not actually a change in the total size of the inorganic particles themselves, but, rather, a chemical reaction leading to a partial change in its composition. The above conversion can also attain photo chemically. It can be detected using X-ray photo electron spectroscopy.

The optical properties (absorption and/or emission wavelengths) of the inorganic particles can be altered correspondingly. It has to be noted that a steady relationship exists between temperature increase and change in particle size. The higher treatment temperature after production, the more the change of the inorganic particles and hence the resulting change in optical properties.

It follows from the above that when such particles are produced to have a particular size at room temperature, they will absorb and/or emit at certain wavelengths. Upon heating to elevated temperatures, they will steadily change (increase or decrease) in size as described above and will change their optical properties correspondingly (shift of absorption and of photo-luminescence bands). These changes make the composites of the invention suitable for optical recording according to a first aspect of the present invention. Suitable temperatures are in the range of 100 to 300° C. Such temperatures are reached by lasers used in optical recording techniques. As a rule, the shift occurs in a bathochromic manner, i.e. to higher wave lengths.

According to a second aspect of the invention, the inorganic particles of the invention can be used for quenching the fluorescence of a system having high luminescence efficiency. Such a system is given when the inorganic particles are embedded in an organic passivation layer. This layer stabilizes the surface state so that the above high luminescence efficiency is obtained. Heating the particles to high temperatures can remove the organic molecules from their surfaces, thus quenching the fluorescence. Again, a change in the optical properties of a system is observed that can be used for optical recording. It will be shown later that such fluorescence quenching does not so much cause a wave length shift of the emission band but predominantly has an influence on the intensity of the emitted light.

According to preferred embodiments of the invention, the inorganic particles are CdS, CdTe, CdSe, ZnS, ZnSe, PbS, HgS, HgTe, GaAs, GaP, InAs, InP, and ZnO.

According to another preferred embodiment, the change in size is detectable by a change in the absorption spectrum of the composite polymer.

According to a further preferred embodiment, the inorganic particles of the invention are luminescent particles. According to a still further embodiment, they are round, disc like or rod like in shape with a size of smaller than 10 nm in at least in one direction.

According to yet another preferred embodiment, the polymer is a polymer of an acrylate, epoxy or thiolene monomer. Alternatively, the polymer may contain carboxylic acid groups and/or carboxylic acid salts. According to still another preferred embodiment, the polymer is chemically cross-linked.

It is preferred that the inorganic particles are contained in the polymer in an amount of 1 to 60 percent by weight, based on the total weight of the composite polymer.

One method for obtaining the above inorganic particles is by precipitation in a solution containing their metal salts. Among them, the sulfides, selenides, tellurides and phosphides (CdS, CdTe, CdSe, ZnS, ZnSe, PbS, HgS, HgTe, GaP, InP) cab be precipitated using H₂S, H₂Se, H₂Te or PH₃ or their alkali metal salts. AsH₃ and As(CH₃)₃ can be used in the preparation of arsenides (GaAs, InAs,). Oxides such as ZnO can be obtained by addition of a base such as a hydroxide.

Another other method of making such particles is by thermolysis of organo metallic precursors such as dimethyl cadmium and cadmium acetate at elevated temperatures using coordinating solvents such as tri-n-octylphosphine(oxide) and dodecyl amine.

As mentioned above, suitable particles can be round, rod like or disc like in shape. However, they may also be asymmetric.

One method for producing the optical recording medium of the invention involves dispersion of pre-manufactured inorganic particles in a polymer matrix. For this purpose, nano particles can be produced in an organic solvent in the presence of stabilizing molecules. Subsequently, the particles are added to a polymer solution. Such a polymer solution can be formed into a thin polymer layer containing nano crystals by evaporation of the solvent during spinning the solution on top of a substrate. Polycarbonate polystyrene are well known polymers which can be used for this purpose. However, other polymers may also be used.

Another method for producing the optical recording medium involves in-situ production of the inorganic particles in a polymer matrix. For this purpose, precursor metal salts and or complexes are dissolved in a polymer matrix. Subsequently, the precursors are reduced using reactants to form nano particles as mentioned above. In order to disperse the precursor materials in a polymer matrix, it is necessary to use polymers with solvating or coordinating groups. For this purpose, homopolymers, copolymers as well as block copolymers can be used. Examples of polymers with solvating groups are poly(styrene sulfonic acid), poly(N-alkylpyridinium halide), poly(methyl)acrylic acid, poly(N-vinylpyrrolidone), poly(vinyl ethers), poly(ethylene(propylene) oxide), poly(vinyl methyl ether), poly-(methyl(acrylates), and poly(vinyl buthyl ethers).

According to a preferred embodiment of the invention, the polymer in which the inorganic particles are dispersed comprises a cross-linked network. Such network can be formed using molecules of the basic formulae (I) and (II) shown below which have reactive end groups (A) and (C) such as acrylate, epoxy or thiolene. The network can also contain groups with an ability to form a complex with a metal ion or should have the ability to dissolve it. Hydroxy, carboxylic acid, pyridine and ethylene oxide groups can be used as side or bridging groups (B). The metal ion can be brought into such a network in various phases. It can be brought into the system in the monomeric phase. This can be done by choosing a group B in formula (I) containing a metal atom and polymerizing the system to form a solid film containing the metal atom (M). Such an acrylate is shown by formula (III). In this example, X can be any bridging group. Subsequently, it can be converted to a nano particle. It is also possible to produce a network and then bring in the metal ion by swelling the solvent. An example of such a molecule with acrylate groups is formula (IV).

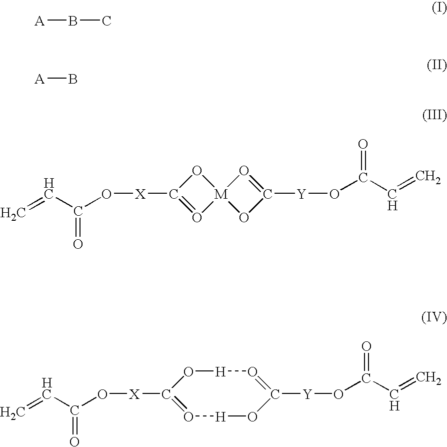

The invention will be described and explained in more detail with reference to preferred examples and to the attached drawings.

FIG. 1 is a view of a conventional recording disc 1 where information 2 is written in tracks 3;

FIG. 2 shows the cross section of the recording disc of FIG. 1;

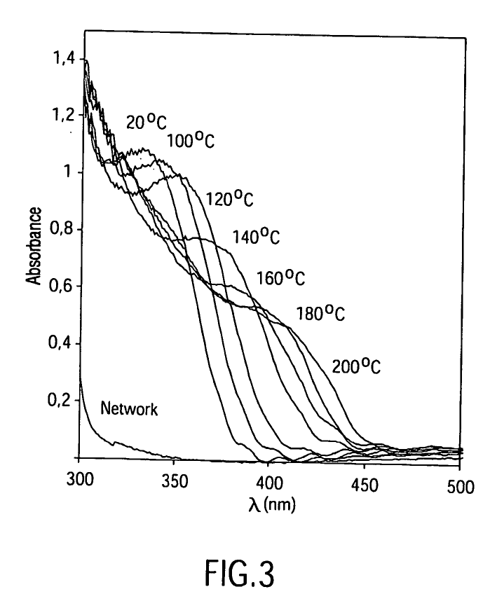

FIG. 3 shows the absorption spectra of polyacrylate based composite polymers according to the first aspect of the invention containing CdS as inorganic particles and being measured as made (room temperature) and after treatment at temperatures between 100 and 200° C.;

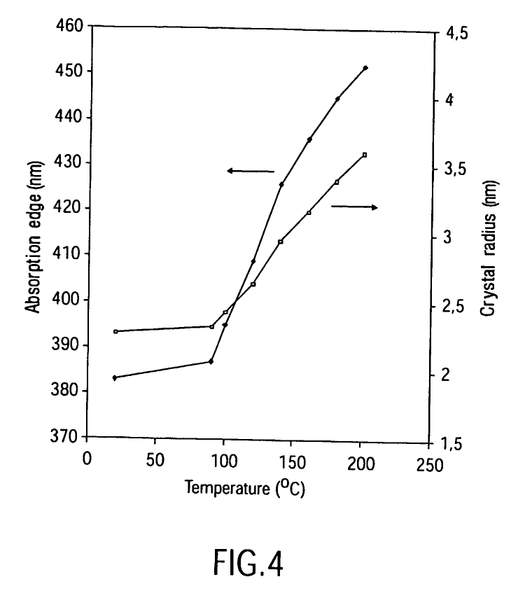

FIG. 4 shows the position (wave length) of the absorption edge λₑ of the absorption spectra of FIG. 3 as well as the underlying CdS crystal radius, both in relation to the treating temperature;

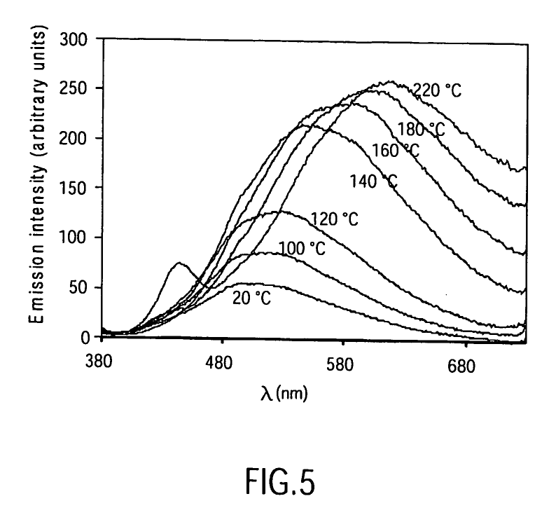

FIG. 5 shows the photo luminescence spectra of the composite polymers of FIG. 3;

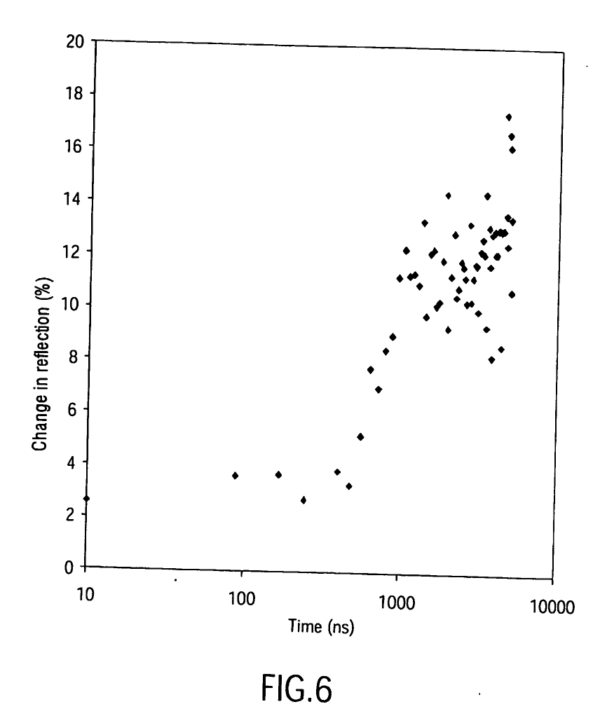

FIG. 6 shows the change in reflection of spots on a polyacrylate based composite polymer according to the invention containing CdS as inorganic particles, the spots having been recorded by laser irradiation at various pulse lengths; and

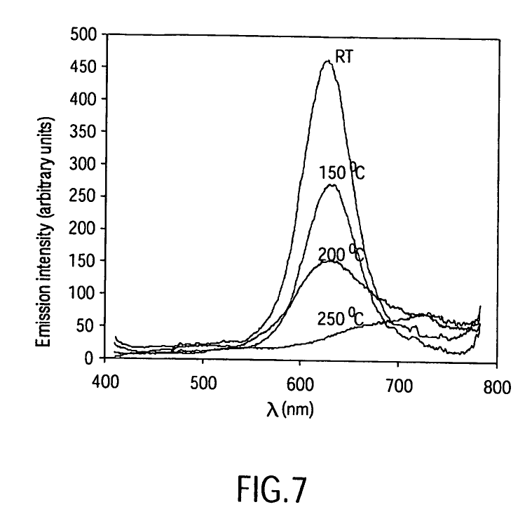

FIG. 7 shows the emission spectra of a polyvinylpyrolidone based composite polymer according to the second aspect of the invention containing CdS as inorganic particles and being measured as made (room temperature) and after treatment at temperatures between 100 and 250° C.

### EXAMPLE 1

Example 1 relates to the first aspect of the invention and utilizes bathochromic shift of the absorption bands caused by heat induced growth of the inorganic particles. Compounds (acrylates) having the following structures were used:

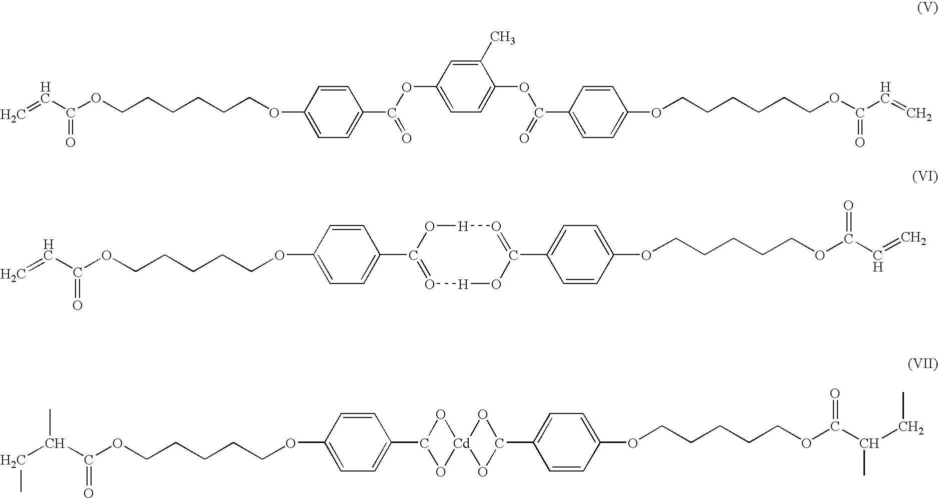

A mixture containing 10% wt compound (V) in compound (VI) was made. The mixture was placed in a cell and polymerization was initiated using the UV radiation from a 10 W fluorescent lamp (Philips PL10). The polymerized films were placed in a solution of containing 3% cadmium acetate dihydrate, 40% ethanol, 7% demineralised water and 50% dichloromethane in order to neutralize the network and incorporate build Cd into compound (VI), converting it to compound (VII). The samples were immersed in the solution for half a day and rinsed in a mixture containing 42% ethanol, 8% demineralised water and 50% dichloromethane to wash away ions not bound to the network. Subsequently, the samples were dried at room temperature and the remnant of the solvent was removed by heating them to 150° C. Using infrared spectroscopy it was found that compound (VI) was totally converted to compound (VII). In order to produce CdS quantum dots, networks containing cadmium were placed in a tube with dry H₂S for 4 h at atmospheric pressure and room temperature. After this treatment; the molecules of compound (VII) reverted back to form (VI) as observed by IR spectroscopy and the fact that CdS crystals were formed.

FIG. 3 shows the spectra measured at room temperature and after heating the sample at various temperatures for two minutes. In this figure, the spectra of the pure network is also given for comparison. It can be seen that the presence of CdS quantum dots gives rise to an absorption band not present in the neat network. Furthermore, the onset of absorption band (λₑ) shifts to higher wavelengths with increasing temperature. The increasing absorption edge indicates that the size of the CdS crystals increases with increasing storage temperature.

The size of the crystal (R) was calculated from the absorption edge using the following empirical formula:
R(nm)=0.1/(0.1338=0.0002345*λₑ)

The results are shown in FIG. 4. It can be seen that during heating of the sample, the size of the crystals remains almost unaltered up to 80° C. above which a continuous increase is observed as a function of the storage temperature.

The photoluminescence spectra of the samples were also measured after storing them at the mentioned treating temperatures. The results are shown in FIG. 5. It can be seen that with increasing temperature the emission maximum moves to higher wavelengths (bathochromic shift) as a result of the increased size of the crystals.

It can be seen that by applying heat, the size of the crystals could be changed and a large change in the position of the emission band could be obtained making the system suitable for optical recording.

Various recording experiments were also carried out on such layers. The layer was prepared as described above. Using a laser beam, CdS crystals were produced in situ. A detectible line could be recorded in such a layer by local heating.

For high speeds, a static tester with a solid state laser with a wavelength of λ=405 nm was used. An objective lens with a numerical aperture (NA) of 0.85 was used. The power of the laser was set to 10 mW and spots were recorded at various pulse lengths. Each time before and after recording, the reflection from the spot was measured. The change in reflection is plotted in FIG. 6 as a function of laser pulse length.

It can be seen in FIG. 6 that one observes already at 10 ns a sufficient change in reflectivity of the sample indicating that it is possible to make a recording at such a short time. In the same figure, it can also be seen that pulses longer than 500 ns could produce larger changes in reflection. This effect is associated with the behavior shown in FIG. 3. As the crystals grow, further absorption around 400 ns increase initially gradually and as they reach a certain size, they show a rapid increase in absorption at this wavelength.

It is concluded from the above experimental findings (particularly from FIG. 5) that the treating temperature (i.e. the temperature to which the inorganic particles are heated by the recording laser) should be higher than 80° C. Further details depend on the lo circumstances given. On the one hand, one would like to have the temperature as high as 160 to 220° C. for reasons of signal yield. On the other hand, high temperatures cannot be achieved in high speed recording. These are contradictory requirements which must be bridged by a technical optimization.

### EXAMPLE 2

Example 2 relates to the second aspect of the invention and utilizes heat induced fluorescence quenching. CdTe particles were used. The particles were synthesized following the procedure described in the literature. Such particles are stabilized by thiol molecules and show a very high luminescence. A polymer (polyvinylpyrolidone) was added to such a mixture and a polymer layer containing CdTe particles could be produced on a glass substrate. At room temperature, the layer showed very strong luminescence. However after heating above 250° C., a large decrease in luminescence was observed as shown in FIG. 7. As indicated above, the change in optical properties lies predominantly in the intensity of the emission bands while their wave length is constant. It needs a high temperature of 250° C. to shift the band bathochromically.

1. An optical recording medium comprising inorganic particles of nanometer size capable to undergo a change in size upon heating at a temperature above room temperature; and a polymer in which the inorganic particles are dispersed to form a composite polymer.

2. The recording medium of claim 1 wherein the temperature above room temperature is in the range of 100 to 300° C., preferably higher than 80.

3. The recording medium of claim 1 wherein the change in size is detectable by a change in the absorption spectrum of the composite polymer.

4. The recording medium of claim 1 wherein the inorganic particles are luminescent particles.

5. The recording medium of claim 1 wherein the inorganic particles are CdS, CdTe, CdSe, ZnS, ZnSe, PbS, HgS, HgTe, GaAs, GaP, InAs, InP, or ZnO.

6. The recording medium of claim 5 wherein the inorganic particles are round, like disc or rod like with a size of smaller than 10 nm in at least in one direction.

7. The recording medium of claim 1 wherein the polymer is a polymer of an acrylate, epoxy or thiolene monomer.

8. The recording medium of claim 1 wherein the polymer contains carboxylic acid groups and/or carboxylic acid salts.

9. The recording medium of claim 1 wherein the polymer is chemically cross-linked.

10. The recording medium of claim 1 wherein the inorganic particles are contained in the polymer in an amount of 1 to 60 percent by weight, based on the total weight of the composite polymer.
